(19) United States
(12) Patent Application Publication
(10) Pub. No.: US 2017/0078460 A1
(43) Pub. Date: Mar. 16, 2017

(54) FRAME FOR MOBILE COMMUNICATION TERMINAL AND METHOD OF MANUFACTURING THE SAME

(71) Applicant: Hee Cheol Park, Daegu (KR)

(72) Inventors: Sang Hoon LEE, Ulsan-si (KR); Joon Soo KIM, Chunan-si (KR); Hee Cheol PARK, Daegu (KR); Tae Young CHOI, Ulsan (KR); Seung Ho SONG, Seoul (KR)

(73) Assignee: Hee Cheol PARK, Daegu (KR)

(21) Appl. No.: 15/247,593

(22) Filed: Aug. 25, 2016

(30) Foreign Application Priority Data
Sep. 16, 2015 (KR) 10-2015-0131161

(51) Int. Cl. H04M 1/02

(52) U.S. Cl. CPC H04M 1/0249; H04M 1/0277

(57) ABSTRACT

Disclosed herein are a frame for a mobile communication terminal consisting of an inner frame, to which a printed circuit board and electronic components are mounted, and an outer frame provided outside the inner frame, and a method of manufacturing the same. The inner frame is formed with a slide protrusion and the outer frame is formed with a guide rail so that the outer frame may be slidably coupled to the inner frame, thereby enhancing the coupling of the inner and outer frames and simultaneously maximizing productivity thereof.

### CROSS-REFERENCE TO RELATED APPLICATIONS

This application claims the benefit of Korean Application No. 10-2015-0131161, filed Sep. 16, 2015, in the Korean Intellectual Property Office. The disclosure of the document named above is incorporated herein by reference.

### BACKGROUND OF THE INVENTION

Field of the Invention

Exemplary embodiments of the present invention relate to a frame for a mobile communication terminal and a method of manufacturing the same, and more particularly, to a frame for a mobile communication terminal consisting of an inner frame, to which a printed circuit board and electronic components are mounted, and an outer frame provided outside the inner frame, and a method of manufacturing the same.

Description of the Related Art

A mobile communication terminal generally includes a frame to which a display module, a PCB, a camera module, a speaker, a battery, and the like are mounted. The frame of the mobile communication terminal is manufactured in a unibody form by processing such as press working, die casting, or machining.

The press working is a process of forming and bonding a sheet material using a press, and it has disadvantages in that the frame has a low degree of freedom in design and is heavy in weight.

The die casting has advantages in that the frame can be manufactured of a material such as magnesium or aluminum alloy so as to be light in weight while being designed in various shapes. However, when surface treatment such as anodizing is performed afterward, the surface of the frame may not be uniform and easy on the eye.

The machining is a process of forging, extruding, or cutting a material such as aluminum, and it has advantages capable of increasing the structural stiffness of the frame and significantly improving the dissipation of heat therefrom. However, the machining has disadvantages of low productivity and high manufacturing costs.

Meanwhile, when an inner frame and an outer frame are independently manufactured and then assembled to each other, post-treatment such as anodizing can be performed on the outer frame. However, due to the assembly of the inner and outer frames, the structural stiffness of the frames and the dissipation of heat therefrom may be lowered, and costs to manufacture the frames may be increased.

In addition, when an outer frame is manufactured of metal, it takes a long time to produce the frame, resulting in low productivity and high manufacturing costs. For this reason, the mobile communication terminal is being mostly applied in such a manner that an outer frame is made of plastic by injection molding and an inner frame is made of metal.

### SUMMARY OF THE INVENTION

Accordingly, the present invention has been made in view of the above-mentioned problems, and an object thereof is to provide a frame for a mobile communication terminal in which an outer frame is able to be strongly coupled to an inner frame, and a method of manufacturing the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with one aspect of the present invention, a frame for a mobile communication terminal includes an inner frame to which a printed circuit board and an electronic component are mounted, the inner frame having a slide protrusion formed at an edge thereof, and an outer frame having a guide rail formed on an inside wall thereof such that the slide protrusion of the inner frame is fitted into the guide rail, the outer frame being slidably coupled to the inner frame in a lateral direction thereof.

Each of the slide protrusion and the guide rail may have a dovetail shape in section.

The slide protrusion may protrude toward the inner frame along the inside wall of the outer frame, and the guide rail may be formed along the edge of the inner frame so as to receive the slide protrusion.

The outer frame may consist of a plurality of portions.

The outer frame may consist of a first outer frame having a “[” shape, and a second outer frame having a “]” shape.

The first and second outer frames may be slidably coupled to the inner frame with a predetermined distance therebetween.

The inner frame or the outer frame may be made of any one of aluminum, titanium, stainless steel, and carbon fiber.

In accordance with another aspect of the present invention, a method of manufacturing the frame for a mobile communication terminal includes processing the inner frame having the slide protrusion, processing the outer frame having the guide rail, and slidably fitting and coupling the slide protrusion of the inner frame into the guide rail of the outer frame.

The method may further include pressing the frame for a mobile communication terminal so as to press and fix the inner and outer frames, in a state in which the outer frame is slidably coupled to the inner frame.

The processing the outer frame may include processing a body part of the outer frame in a ring shape, and cutting the body part processed in the ring shape so as to divide the body part into a plurality of portions.

The processing the outer frame may further include forming the guide rail in the body part of the outer frame.

In the processing the inner frame, the inner frame may be processed by die casting.

In the processing a body part of the outer frame, the body part of the outer frame may be processed by extruding.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a frame for a mobile communication terminal according to an embodiment of the present invention before inner and outer frames constituting the frame are coupled to each other;

FIG. 2 is a perspective view illustrating the frame for a mobile communication terminal according to the embodiment of the present invention after the inner and outer frames constituting the frame are coupled to each other;

FIG. 3 is a top view illustrating the frame for a mobile communication terminal according to the embodiment of the present invention;

FIG. 4 is a cross-sectional view illustrating a side of FIG. 3;

FIG. 5 is a flowchart illustrating a method of manufacturing a frame for a mobile communication terminal according to an embodiment of the present invention;

FIG. 6 is a conceptual view schematically illustrating the method of manufacturing a frame for a mobile communication terminal of FIG. 5;

FIG. 7 is a cross-sectional view illustrating a side of a frame for a mobile communication terminal according to another embodiment of the present invention after inner and outer frames constituting the frame are coupled to each other; and

FIG. 8 is a cross-sectional view illustrating a side of a frame for a mobile communication terminal according to a further embodiment of the present invention after inner and outer frames constituting the frame are coupled to each other.

### DETAILED DESCRIPTION OF THE EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

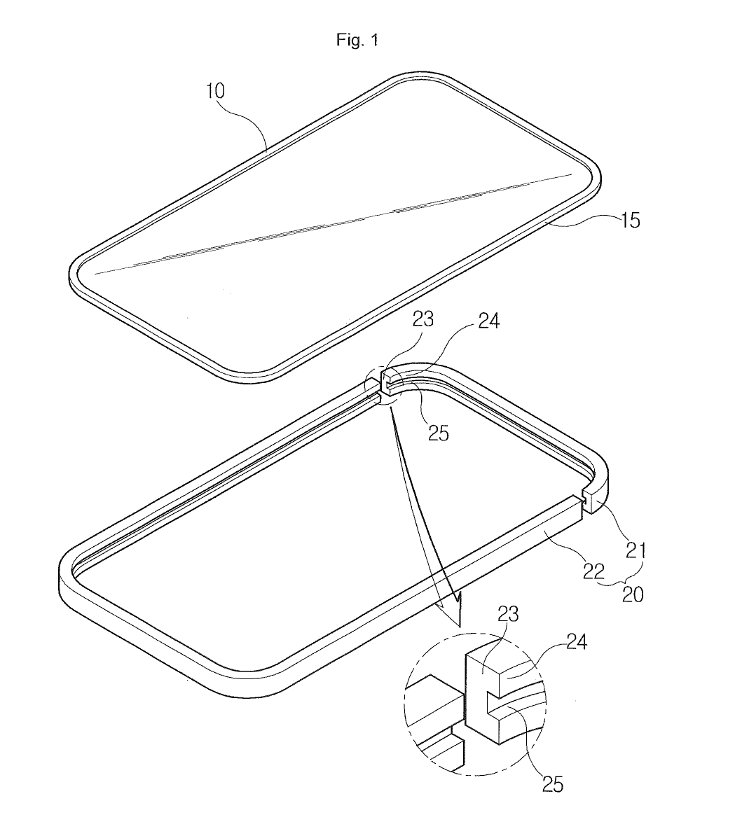

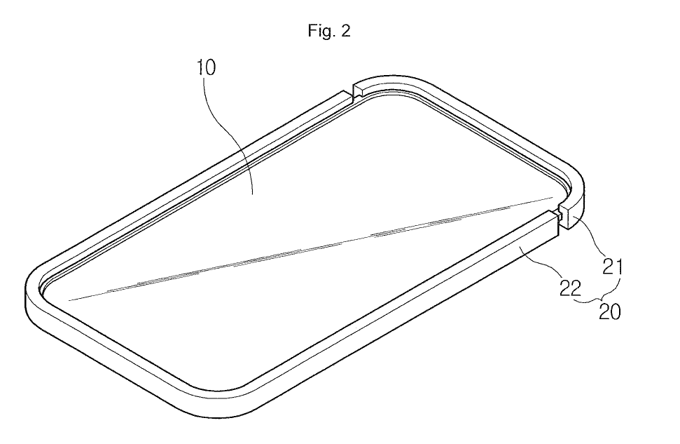

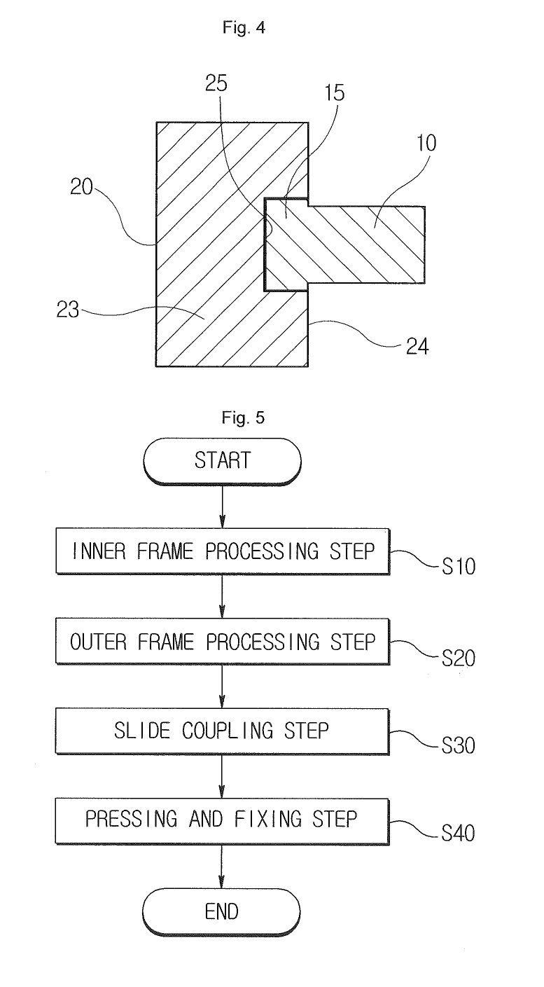

Referring to FIGS. 1 to 4, a frame for a mobile communication terminal according to an embodiment of the present invention includes an inner frame 10 to which a printed circuit board and electronic components are mounted and which has a slide protrusion 15 formed at the edge thereof, and an outer frame 20 which has a guide rail 25 formed on an inside wall 24 thereof such that the slide protrusion 15 of the inner frame 10 is fitted into the guide rail 25, and is slidably coupled to the inner frame 10 in the lateral direction thereof.

Although the slide protrusion 15 of the inner frame is illustrated to be continuous in the embodiment of the present invention, it may be discontinuous.

The outer frame 20 may consist of a plurality of portions. When the outer frame 20 consists of the portions by processing such as cutting, the slide protrusion 15 of the inner frame 10 may be fitted into the guide rail 25 of the outer frame 20.

The slide coupling method may be classified into, according to the dimensional relationship between a hole and a shaft, three types of interference fit in which no gap is present therebetween, transition fit in which the gap is present or not present therebetween, and clearance fit in which the gap is always present therebetween. In the present invention, the inner and outer frames may be coupled to each other by all of the three fit manners. However, the inner and outer frames are preferably coupled to each other by the clearance fit in which the inner frame is barely deformable during the sliding thereof.

When the slide protrusion 15 of the inner frame has a smaller size than the width of the guide rail 25 of the outer frame, the slide protrusion 15 may easily slide into the guide rail 25 in the clearance fit manner.

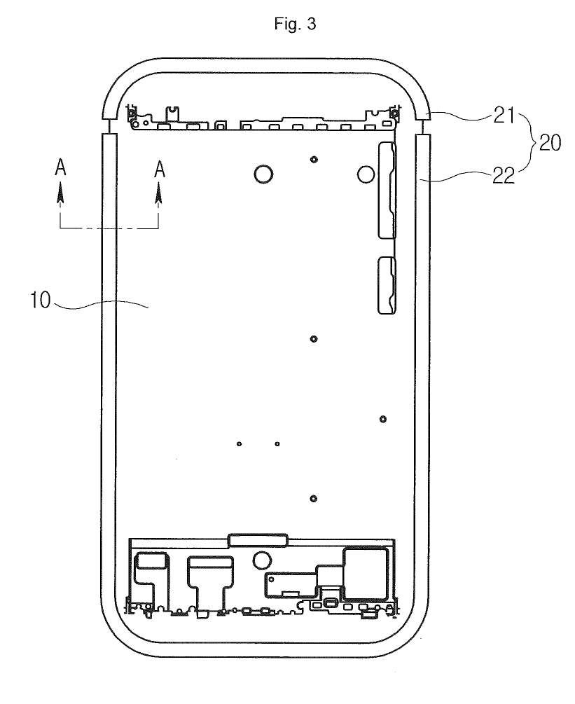

The outer frame 20 may have outer frame portions configured in various shapes and numbers. However, referring to FIG. 3, the outer frame 20 preferably includes a first outer frame 21 having a “[” shape, and a second outer frame 22 having a “]” shape. In this case, since the outer frame is easily processed, the productivity thereof may be increased.

The first and second outer frames 21 and 22 are slidably coupled to the inner frame 10 with a predetermined distance therebetween. In the related art, frequency interference occurs between an inner frame and an outer frame since the whole edge of the inner frame is coupled to the outer frame. Accordingly, in order to resolve this problem, it is necessary to process the outer frame with a predetermined distance therein. However, in the present invention, since the first and second outer frames 21 and 22 are slidably coupled to the inner frame 10 with a predetermined distance therebetween, it is possible to resolve a frequency interference issue.

Although the inner frame 10 or the outer frame 20 may be processed using various materials, it is preferably processed using a material such as aluminum (Al), stainless steel, titanium (Ti), or carbon fiber. Aluminum has properties of light weight and high corrosion resistance and durability, and is therefore used to reduce the weight of the mobile communication terminal. Stainless steel has properties of high corrosion resistance, durability, and heat resistance, and titanium (Ti) has properties of light weight and high corrosion resistance. Carbon fiber has properties of high heat resistance and shock resistance.

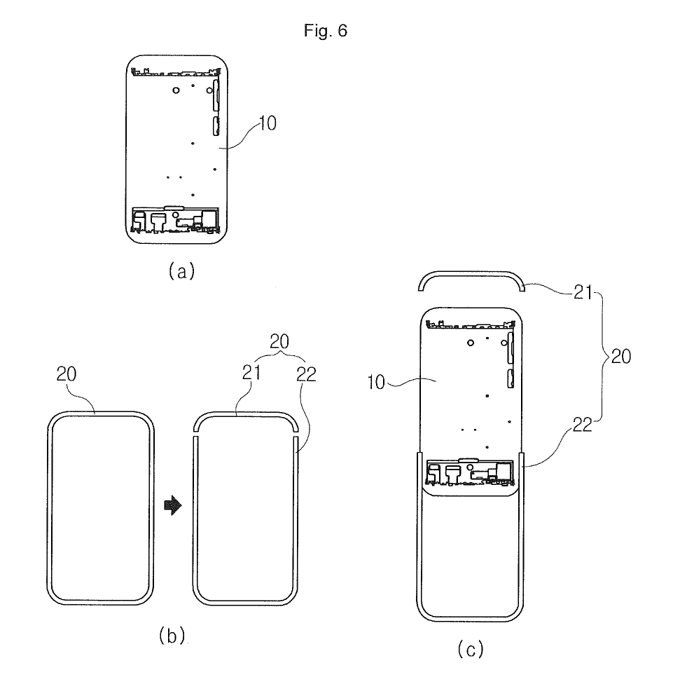

The method of manufacturing a frame for a mobile communication terminal through the processing and coupling of the inner and outer frames 10 and 20 will be described in detail with reference to FIGS. 5 and 6. The method includes a step (S10) of processing the inner frame 10 having the slide protrusion 15, a step (S20) of processing the outer frame 20 having the guide rail 25, a step (S30) of slidably fitting and coupling the slide protrusion 15 of the inner frame 10 into the guide rail 25 of the outer frame 20, and a step (S40) of pressing the frame for a mobile communication terminal so as to press and fix the inner and outer frames which are slidably coupled to each other.

Referring to FIG. 6(a), in the step of processing the inner frame (S10), the inner frame 10 is processed by die casting. When the inner frame 10 is cast by die casting, it has a smooth surface and high dimensional accuracy. Thus, it is possible to lower the defect rate of the inner frame 10 to which a display module, a PCB, a camera module, a speaker, a battery, and the like are mounted.

In addition, in the step of processing the inner frame (S10), the inner frame 10 may be made of a material such as stainless steel or titanium (Ti) by press forming.

Referring to FIG. 6(b), the step of processing the outer frame (S20) includes a step of processing the body part of the outer frame 20 in a ring shape, and a step of cutting the body part 23 processed in the ring shape so as to divide the body part into a plurality of portions.

In the step of processing the body part of the outer frame, the body part 23 of the outer frame 20 is processed by extruding. In this case, various colors may be obtained by coloring the body part through anodizing.

The step of processing the outer frame (S20) further includes a step of forming the guide rail 25 in the body part 23 of the outer frame. The guide rail is formed in such a manner that the inside wall 24 of the outer frame is cut so as to be formed with a groove.

In the step of processing the outer frame (S20), the body part 23 of the outer frame may be cut shortly so as to have a predetermined side length. In this case, the first and second outer frames 21 and 22 separated by single cutting may be slidably coupled to each other with a predetermined distance therebetween.

Referring to FIG. 6(c), in the slide coupling step (S30), the slide protrusion 15 of the inner frame 10 is fitted into the guide rail 25 of the outer frame 20, and is then pushed along the guide rail 25.

During the slide coupling step (S30), a gap is present between the slide protrusion 15 of the inner frame 10 and the guide rail 25 of the outer frame 20. In this case, the inner frame 10 may be decoupled from the outer frame 20. Therefore, the coupled inner and outer frames 10 and 20 may be pressed and fixed using a press (S40).

In the pressing and fixing step (S40), the back surface of the inner frame on which the outer frame 20 is located is pressed against the upper surface of the outer frame facing the back surface. Accordingly, the guide rail of the outer frame is deformed and the gap between the outer frame 20 and the inner frame 10 is removed. Consequently, the inner frame is not slidable relative to the outer frame, and is strongly fixed to the outer frame.

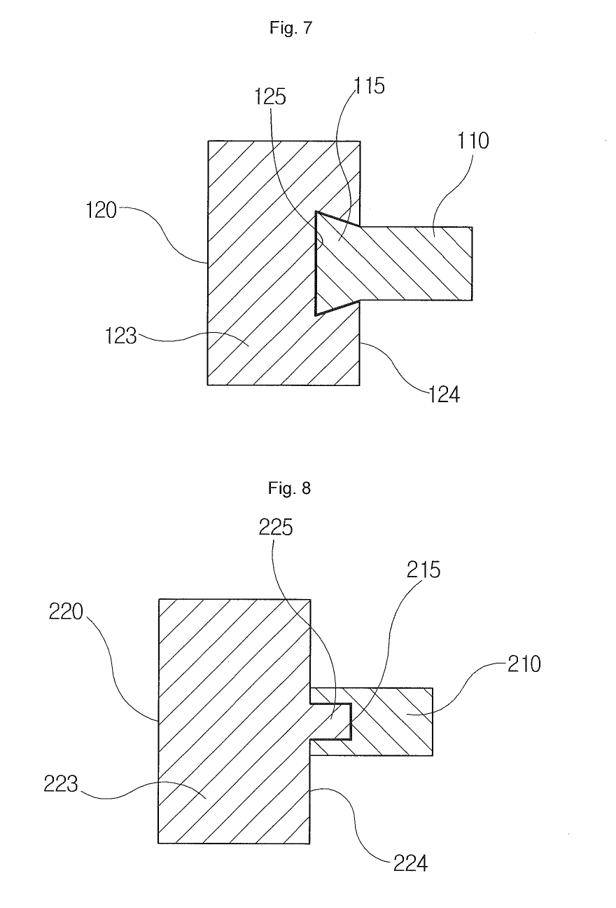

FIG. 7 illustrates another embodiment of a slide protrusion and a guide rail. In the present embodiment, each of a slide protrusion 115 and a guide rail 125 has a dovetail shape in section. In this case, the coupling force between the slide protrusion and the guide rail is significantly increased due to the limit of insertion in one direction. When the contact area between the slide protrusion 115 and the guide rail 125 is increased thanks to the dovetail shape, thermal diffusion and thermal dissipation are increased, thereby improving physical characteristics such as conductivity.

FIG. 8 illustrates a further embodiment of a slide protrusion and a guide rail. In the present embodiment, a slide protrusion 225 protrudes toward an inner frame 210 along an inside wall 224 of an outer frame 220, and a guide rail 215 is formed along the edge of the inner frame 210 so as to receive the slide protrusion 225.

As is apparent from the above description, according to a frame for a mobile communication terminal and a method of manufacturing the same, an outer frame can be manufactured separately from and be easily coupled to an inner frame in a sliding manner. In addition, the outer frame can be strongly coupled to the inner frame by pressing.

While the present invention has been described with respect to the specific embodiments, it will be apparent to those skilled in the art that various changes and modifications may be made without departing from the spirit and scope of the invention as defined in the following claims.

What is claimed is:

1. A frame for a mobile communication terminal, comprising:
an inner frame to which a printed circuit board and an electronic component are mounted, the inner frame having a slide protrusion formed at an edge thereof; and
an outer frame having a guide rail formed on an inside wall thereof such that the slide protrusion of the inner frame is fitted into the guide rail, the outer frame being slidably coupled to the inner frame in a lateral direction thereof.

2. The frame according to claim 1, wherein each of the slide protrusion and the guide rail has a dovetail shape in section.

3. The frame according to claim 1, wherein:
the slide protrusion protrudes toward the inner frame along the inside wall of the outer frame; and
the guide rail is formed along the edge of the inner frame so as to receive the slide protrusion.

4. The frame according to claim 1, wherein the outer frame consists of a plurality of portions.

5. The frame according to claim 4, wherein the outer frame consists of a first outer frame having a “[” shape, and a second outer frame having a “]” shape.

6. The frame according to claim 5, wherein the first and second outer frames are slidably coupled to the inner frame with a predetermined distance therebetween.

7. The frame according to claim 1, wherein the inner frame or the outer frame is made of any one of aluminum, titanium, stainless steel, and carbon fiber.

8. A method of manufacturing the frame for a mobile communication terminal according to claim 1, comprising:
processing the inner frame having the slide protrusion;
processing the outer frame having the guide rail; and
slidably fitting and coupling the slide protrusion of the inner frame into the guide rail of the outer frame.

9. The method according to claim 8, further comprising pressing the frame for a mobile communication terminal so as to press and fix the inner and outer frames, in a state in which the outer frame is slidably coupled to the inner frame.

10. The method according to claim 8, wherein the processing the outer frame comprises:
processing a body part of the outer frame in a ring shape; and
cutting the body part processed in the ring shape so as to divide the body part into a plurality of portions.

11. The method according to claim 10, wherein the processing the outer frame further comprises forming the guide rail in the body part of the outer frame.

12. The method according to claim 8, wherein, in the processing the inner frame, the inner frame is processed by die casting.

13. The method according to claim 10, wherein, in the processing a body part of the outer frame, the body part of the outer frame is processed by extruding.
